(19) United States
(12) Patent Application Publication
(10) Pub. No.: US 2017/0288931 A1
(43) Pub. Date: Oct. 5, 2017

(54) Method and Receiver in a Wireless Communication System

(71) Applicant: Huawei Technologies Co., Ltd., Shenzhen (CN)

(72) Inventor: Fredrik Rusek, Kista (SE)

(21) Appl. No.: 15/624,362

(22) Filed: Jun. 15, 2017

Related U.S. Application Data
(63) Continuation of application No. PCT/EP2014/077781, filed on Dec. 15, 2014.

(51) Int. Cl. H04L 27/26

(52) U.S. Cl. CPC H04L 27/2657

(57) ABSTRACT

A receiver and method applied to the receiver, for estimating a normalized frequency offset value ε between a transmitter and the receiver in a wireless communication system, based on Orthogonal Frequency Division Multiplexing (OFDM), where the method includes receiving a first pilot signal (yᵣ₁) and a second pilot signal (yᵣ₂), from the transmitter, determining a correlation model to be applied based on correlation among involved sub-carrier channels at the yᵣ₁ and the yᵣ₂, computing three complex values μ₋₁, μ₀, and μ₁, by a complex extension of a log-likelihood function (λ(ε)), based on the determined correlation model, and estimating the ε by finding a maximum value of a Karhunen-Loeve approximation of the λ(ε), based on the computed three complex values μ₋₁, μ₀, and μ₁.

### CROSS-REFERENCE TO RELATED APPLICATION

This application is a continuation of International Patent Application No. PCT/EP2014/077781 filed on Dec. 15, 2014, which is hereby incorporated by reference in its entirety.

### TECHNICAL FIELD

Implementations described herein generally pertain to a receiver and a method in a receiver, and more particularly to a mechanism for estimating frequency offset between transmitter and receiver in a wireless communication system.

### BACKGROUND

Orthogonal Frequency Division Multiplexing (OFDM) is the chosen modulation technique in contemporary systems such as 3rd Generation Partnership Project (3GPP) Long Term Evolution (LTE) and WI-FI. A severe problem of OFDM is frequency offsets between the transmitter and the receiver. This is referred to as Carrier Frequency Offset (CFO). The effect of a CFO is that orthogonality among the OFDM sub-carriers is lost. In the case that the CFO would be known to the receiver, it may compensate for the CFO by a frequency shift, and orthogonality is assured. Hence, mitigating CFOs is equivalent to the problem of estimating the CFO from the received data.

The CFO may be broken up into two parts, the Integer Frequency Offset (IFO) and the Fractional Frequency Offset (FFO).

ε_{CFO}=ε_{IFO}+ε_{FFO},

where ε_{IFO} is an integer multiplied by the sub-carrier spacing and ε_{FFO} is limited in magnitude to half the sub-carrier spacing. In LTE, the sub-carrier spacing is 15 kilohertz (kHz), so the FFO is limited to 7.5 kHz in magnitude, and the IFO is a multiple of 15 kHz.

During initial synchronisation, the precise value of ε_{IFO} is obtained. Hence, the remaining task is to estimate the FFO. Throughout this disclosure, it will be assumed that the IFO is already estimated. It is standard notational procedure to normalise all offsets by the subcarrier spacing such that the FFO is limited to ε_{FFO}∈[−½,½].

The FFO may be estimated based on the received signals. In this work it may be assumed that two OFDM symbols are at our disposal. A condition for the FFO estimation to work is that these two symbols comprises training symbols, also known as pilot symbols. If so, then based on these two OFDM symbols it may be aimed at proposing a near-optimal FFO estimator algorithm capable of dealing with an arbitrary FFO in the range ε_{FFO}∈[−½,½].

In a legacy solution, the likelihood function of the CFO ε given the two received signals reads:

$$λ ( ɛ ) = - {[ \begin{matrix}{P}_{0}^{- 1} {QD}_{0}^{H} ( ɛ ) {y}_{0} \\ {P}_{t}^{- 1} {QD}_{i}^{H} ( ɛ ) {y}_{t}\end{matrix} ]}^{H} {( Λ + {N}_{0} {I}_{2 {N}_{FFT}} )}^{- 1} [ \begin{matrix}{P}_{0}^{- 1} {QD}_{0}^{H} ( ɛ ) {y}_{0} \\ {P}_{t}^{- 1} {QD}_{t}^{H} ( ɛ ) {y}_{t}\end{matrix} ]$$

where Pₖ is a diagonal matrix with pₖ along its diagonal, and the matrix Λ is the covariance matrix of the channel in the frequency domain, i.e.,

$$Λ = E [ {[ \begin{matrix}diag ( {H}_{0} ) \\ diag ( {H}_{t} )\end{matrix} ] [ \begin{matrix}diag ( {H}_{0} ) \\ diag ( {H}_{t} )\end{matrix} ]}^{H} ] ,$$

where diag(X) is a column vector with the its elements taken from the main diagonal of X. As can be seen, all quantities needed to evaluate λ(ε) are well defined except for Λ. An assumption may be made:

$$Λ = [ \begin{matrix}I & I \\ I & I\end{matrix} ] .$$

This reduces the complexity of evaluating λ(ε), and is also a decent choice when no prior information is present of the channel covariance Λ. However, unfortunately this assumption may not coincide with reality.

Subsequently in the legacy method, three values of λ(ε), are computed:

μ₋₁=λ(−1/tΔ)

μ₀=λ(0)

μ₁=λ(1/tΔ).

Due to the large dimensions of the matrices involved in the formula for λ(ε), these three values are computationally heavy to reach. An important observation is that the three computed values, μ₋₁, μ₀, μ₁, are sufficient in order to evaluate λ(ε) at any other value of ε. That is, the function λ(ε) is three dimensional and when the three values have been computed (with quite some effort), all other values are computationally cheap to obtain. Based on this observation, a low-complexity method to estimate c based on μ₋₁, μ₀, μ₁ is then formulated.

In the case that the OFDM channels H₀ and Hₜ are correlated according to the simplified correlation model Λ used in the legacy method, the legacy method is optimal (in the maximum likelihood (ML) sense) and cannot be further improved. However, the correlation model Λ is highly unrealistic as it has the following physical meaning.

Firstly, the channel at sub-carrier k is independent of the channel at all other sub-carriers. In reality, the channels at two adjacent sub-carriers are virtually the same, so the assumption made in the legacy correlation model Λ is highly unrealistic.

Secondly, the channel at OFDM symbol t is identical to the one at time 0. In reality, due to Doppler effects, the two channels may be strongly correlated, but they are essentially never identical.

Due to this, the legacy method suffers from performance degradations compared with an estimator that would use the true channel correlation.

Thus, there is room for improvement when estimating the CFO.

### SUMMARY

It is therefore an object to obviate at least some of the above mentioned disadvantages and to improve the performance in a wireless communication system.

This and other objects are achieved by the features of the appended independent claims. Further implementation forms are apparent from the dependent claims, the description and the figures.

According to a first aspect, a receiver is provided and configured to estimate a normalised frequency offset between a transmitter and the receiver in a wireless communication system, based on OFDM. The receiver comprises a receiving circuit configured to receive a first pilot signal yᵣ₁ and a second pilot signal yᵣ₂ from the transmitter. Also, the receiver comprises a processor configured to determine a correlation model based on correlation among involved sub-carrier channels at the first pilot signal and the second pilot signal. Further, the processor is configured to compute three complex values μ₋₁, μ₀, and μ₁, by a complex extension of a log-likelihood function λ(ε), based on the determined correlation model. The processor is further configured to estimate the normalised frequency offset value ε by finding a maximum value of the log-likelihood function λ(ε), based on the computed three complex values μ₋₁, μ₀, and μ₁.

Thereby, an ML estimation, or near-ML estimation of the frequency offset is provided, which improves significantly and non-trivially over the currently conventional solutions at an affordable complexity cost. Using the transmitted pilot signals yᵣ₁, yᵣ₂ that anyway are transmitted by the transmitter for other purposes, an estimation of the FFO may be made without addition of any dedicated signalling, which is an advantage. Thanks to the herein disclosed aspect, FFO may be estimated considerably faster and with less computational effort than according to conventional solutions such as the extended baseline algorithm. Thereby, an improved and near optimal algorithm in the sense that it is extremely close to exact ML estimation is achieved. Thus an improved performance within a wireless communication system is provided.

In a first possible implementation of the receiver according to the first aspect, wherein the processor is configured to determine correlation model based on any of Extended Pedestrian A (EPA), Extended Vehicular A (EVA), Extended Typical Urban (ETU) correlation models when the correlation among involved sub-carrier channels at the first pilot signal yᵣ₁ and the second pilot signal yᵣ₂ is known.

By selecting an appropriate correlation model a better adaptation to realistic transmission conditions is made, resulting in an improved estimation of the frequency offset value E.

In a second possible implementation of the receiver according to the first aspect, or the first possible implementation thereof, the processor may be configured to determine the correlation model by computing QΣ₀Q^{H}, where Q is an Inverse Fast Fourier Transform (IFFT) matrix and Σ₀ is:

$${\sum }_{0} = [ \begin{matrix}\frac{{N}_{FFT}}{{N}_{CP}} & & & & & \\ & ⋱ & & & & \\ & & \frac{{N}_{FFT}}{{N}_{CP}} & & & \\ & & & 0 & & \\ & & & & ⋱ & \\ & & & & & 0\end{matrix} ] ,$$

where Σ₀ is a diagonal matrix comprising the eigenvalues of the covariance among the sub-carriers at any given OFDM symbol, N_{cp} is length of a Cyclic Prefix (CP), and N_{FFT} is number of sub-carriers of the received pilot signals yᵣ₁, yᵣ₂.

Thereby, a further improved adaptation to realistic transmission conditions is made in cases when correlation among said sub-carrier channels is unknown, resulting in an improved estimation of the frequency offset value ε.

In a third possible implementation of the receiver according to the first aspect, or any previous possible implementation thereof, the processor is configured to approximate the maximum value of the log-likelihood function λ(ε) by a Karhunen-Loeve approximation of λ(ε), based on the computed three complex values μ₋₁, μ₀, and μ₁, where:

μ₋₁=λ_{c}(−1/tΔ)

μ₀=λ_{c}(0)

μ₁=λ_{c}(1/tΔ),

where t is the distance between the received pilot signals yᵣ₁, yᵣ₂, Δ=(N_{FFT}+N_{cp})/N_{FFT}.

By performing the disclosed estimation by the quasi ML method, but not a full ML algorithm, accurate frequency offset estimation is achieved, without introducing the complex, time consuming and resource demanding efforts that a full ML algorithm would require. Thereby, time and computational power are saved.

In a fourth possible implementation of the receiver according to the third possible implementation of the first aspect, the processor is configured to perform the Karhunen-Loeve approximation of λ(ε), wherein the log-likelihood function λ(ε) satisfies:

λ(ε)=Re(λc(ε)).

Thereby an appropriate definition of the log-likelihood function λ(ε) is achieved, leading to a further improved estimation of the normalised frequency offset value ε.

In a fifth possible implementation of the receiver according to the first aspect, or any previous possible implementation thereof, the processor may be configured to perform the Karhunen-Loeve approximation of λ_{c}(ε), given by:

λ_{c}(ε)≈α₋₁exp(−i2πε(Δt−0.5)+α₀exp(−i2πε(Δt)+α₁exp(−i2πε(Δt+0.5),

where the three coefficients are chosen so that,

μ₋₁=λ_{c}(−1/tΔ)

μ₀=λ_{c}(0)

μ₁=λ_{c}(1/tΔ)

is satisfied, and wherein the Karhunen-Loeve representation of the likelihood function is then taken as:

λ(ε)≈Re(λ_{c}(ε))=Re(α₋₁exp(−i2πε(Δt−0.5)+α₀exp(−i2πε(Δt)+α₁exp(−i2πε(Δt+0.5)).

Thanks to the selected Karhunen-Loeve approximation, an appropriate estimation is made without introducing the complex, time consuming and resource demanding efforts that a full ML algorithm would require. Thereby, time and computational power are saved.

In a sixth possible implementation of the receiver according to the first aspect, or any previous possible implementation thereof, the processor is configured to perform the Karhunen-Loeve approximation of λ_{c}(ε), wherein the log-likelihood function λ(ε) is defined as:

λ(ε)=−2Re{\tilde{y}₀(ε)^{H}[(IN₀+Σ₀(1−α))⁻¹−(IN₀+Σ₀(1−α))⁻¹]\tilde{y}ₜ(ε)},

where α represents the correlation between two OFDM symbols in time and

\tilde{y}ₖ(ε)=QYₖ(ε),

where Q is the IFFT matrix and Yₖ(ε) is the Fast Fourier Transform (FFT) of signal k, compensated for the frequency offset ε.

Thereby an appropriate definition of the log-likelihood function λ(ε) is achieved, leading to an improved estimation of the normalised frequency offset value ε.

In a seventh possible implementation of the receiver according to the first aspect, or any previous possible implementation thereof, the processor is configured to estimate the maximum value of the Karhunen-Loeve approximation of the log-likelihood function λ(ε) by application of an optimisation algorithm comprised in the group the Newton-Raphson method, the Secant method, the Backtracking line search, the Nelder-Mead method and/or golden section search, or other similar methods.

Using a known, reliable optimisation algorithm to estimate the maximum value of the Karhunen-Loeve approximation of the log-likelihood function λ(ε), a simplified implementation is enabled.

In an eighth possible implementation of the receiver according to the first aspect, or any previous possible implementation thereof, the processor is configured to estimate the maximum value of the Karhunen-Loeve approximation of the log-likelihood function λ(ε) by selecting P values ε such that ε∈{ε₁, ε₂, . . . , ε_{P}} within [−0.5, 0.5], computing P values of the Karhunen-Loeve approximation of λ(ε) at ε∈{ε₁, ε₂, . . . , ε_{P}}, determining the biggest value of the Karhunen-Loeve approximation of λ(ε), denoted by λₘₐₓ, as λₘₐₓ=max λ(εₘ), 1≦m≦P, and corresponding value of ε denoted εₘₐₓ, and utilising the determined biggest value λₘₐₓ and corresponding value εₘₐₓ as a starting point in a line search algorithm to find the maximum of the Karhunen-Loeve approximation of λ(ε).

Thereby an improved algorithm for estimating the maximum value of the Karhunen-Loeve approximation of the log-likelihood function λ(ε) is achieved, leading to an improved estimation of the frequency offset value ε.

In a ninth possible implementation of the receiver according to the first aspect, or any previous possible implementation thereof, the processor is configured to determine, when having determined the biggest value λₘₐₓ and corresponding value εₘₐₓ, that the maximum value of the Karhunen-Loeve approximation of λ(ε) is within an interval:

$$ɛ ∈ \frac{2 {ɛ}_{max} - 2 - P}{2 P} , \frac{2 {ɛ}_{max} - P}{2 P} .$$

Thereby a further improvement is made, leading to an improved estimation of the frequency offset value ε.

In a tenth possible implementation of the receiver according to the first aspect, or any previous possible implementation thereof, the processor is further configured to find the maximum value of the Karhunen-Loeve approximation of λ(ε) within the determined interval with M iterations, using an optimisation algorithm comprised in the group, such as the Newton-Raphson method, the Secant method, the Backtracking line search, the Nelder-Mead method and/or golden section search, or other similar methods.

Using a known, reliable optimisation algorithm to estimate the maximum value of the Karhunen-Loeve approximation of the log-likelihood function λ(ε) within the determined interval with M iterations, a simplified implementation is enabled.

In an eleventh possible implementation of the receiver according to the first aspect, or any previous possible implementation thereof, the receiver is represented by a User Equipment (UE) and the transmitter is represented by a radio network node.

In a twelfth possible implementation of the receiver according to the first aspect, or any previous possible implementation thereof, the receiver is represented by a radio network node and the transmitter is represented by a UE.

According to a second aspect, a method in a receiver is provided, for estimating a normalised frequency offset value ε between a transmitter and the receiver in a wireless communication system, based on OFDM. The method comprises receiving a first pilot signal yᵣ₁ and a second pilot signal yᵣ₂, from the transmitter. The method further comprises determining a correlation model to be applied based on correlation among involved sub-carrier channels at the first pilot signal yᵣ₁ and the second pilot signal yᵣ₂. Further, the method comprises computing three complex values μ₋₁, μ₀, and μ₁, by a complex extension of a log-likelihood function λ(ε), based on the determined correlation model. The method further comprises estimating the frequency offset value ε by finding a maximum value of a Karhunen-Loeve approximation of the log-likelihood function λ(ε), based on the computed three complex values μ₋₁, μ₀, and μ₁.

Thereby, a ML estimation, or near-ML estimation of the frequency offset is provided, which improves significantly and non-trivially over the currently conventional solutions at an affordable complexity cost. Using the transmitted pilot signals yᵣ₁, yᵣ₂ that anyway are transmitted by the transmitter for other purposes, an estimation of the FFO may be made without addition of any dedicated of signalling, which is an advantage. Therefore, due to the herein disclosed aspect, FFO may be estimated considerably faster and with less computational effort than according to conventional solutions such as the extended baseline algorithm. Thereby, an improved and near optimal algorithm in the sense that it is extremely close to exact ML estimation is achieved. Thus an improved performance within a wireless communication system is provided.

In a first possible implementation of the method according to the second aspect, the determined correlation model comprises any of EPA, EVA, ETU correlation models when the correlation among involved sub-carrier channels at the first pilot signal yᵣ₁ and the second pilot signal yᵣ₂ is known.

By selecting an appropriate correlation model a better adaptation to realistic transmission conditions is made, resulting in an improved estimation of the frequency offset value ε.

In a second possible implementation of the method according to the second aspect, or the first possible implementation thereof, the determined correlation model may be computed as QΣ₀Q^{H}, where Q is the IFFT matrix and Σ₀ is:

$${\sum }_{0} = [ \begin{matrix}\frac{{N}_{FFT}}{{N}_{CP}} & & & & & \\ & ⋱ & & & & \\ & & \frac{{N}_{FFT}}{{N}_{CP}} & & & \\ & & & 0 & & \\ & & & & ⋱ & \\ & & & & & 0\end{matrix} ] ,$$

where Σ₀ is a diagonal matrix comprising the eigenvalues of the covariance among the sub-carriers at any given OFDM symbol, N_{cp} is length of a CP and N_{FFT} is number of sub-carriers of the received pilot signals yᵣ₁, yᵣ₂.

Thereby, a further improved adaptation to realistic transmission conditions is made in cases when correlation among said sub-carrier channels is unknown, resulting in an improved estimation of the frequency offset value ε.

In a third possible implementation of the method according to the second aspect, or any possible implementation thereof, the maximum value of the log-likelihood function λ(ε) is approximated by a Karhunen-Loeve approximation of λ(ε), based on the computed three complex values μ₋₁, μ₀, and μ₁, where:

μ₋₁=λ_{c}(−1/tΔ)

μ₀=λ_{c}(0)

μ₁=λ_{c}(1/tΔ),

where t is the distance between the received pilot signals yᵣ₁, yᵣ₂, Δ=(N_{FFT}+N_{cp})/N_{FFT}, and the likelihood function satisfies λ(ε)=Re(λ_{c}(ε)).

By performing the disclosed estimation by the quasi ML method, but not a full ML algorithm, accurate frequency offset estimation is achieved, without introducing the complex, time consuming and resource demanding efforts that a full ML algorithm would require. Thereby, time and computational power are saved.

In a fourth possible implementation of the method according to the third possible implementation of the second aspect, the log-likelihood function λ(ε) satisfies:

λ(ε)=Re(λ_{c}(ε)).

Thereby an appropriate definition of the log-likelihood function λ(ε) is achieved, leading to a further improved estimation of the normalised frequency offset value ε.

In a fifth possible implementation of the method according to the second aspect, or any previous possible implementation thereof, the Karhunen-Loeve approximation of λ_{c}(ε) is given by:

λ_{c}(ε)≈α₋₁exp(−i2πε(Δt−0.5)+α₀exp(−i2πε(Δt)+α₁exp(−i2πε(Δt+0.5),

where the three coefficients are chosen so that:

μ₋₁=λ_{c}(−1/tΔ)

μ₀=λ_{c}(0),

μ₁=λ_{c}(1/tΔ)

is satisfied, and where the Karhunen-Loeve representation of the likelihood function is then taken as:

λ(ε)≈Re(λ_{c}(ε))=Re(α₋₁exp(−i2πε(Δt−0.5)+α₀exp(−i2πε(Δt)+α₁exp(−i2πε(Δt+0.5)).

Therefore, due to the selected Karhunen-Loeve approximation, an appropriate estimation is made without introducing the complex, time consuming and resource demanding efforts that a full ML algorithm would require. Thereby, time and computational power are saved.

In a sixth possible implementation of the method according to the second aspect, or any previous possible implementation thereof, the log-likelihood function λ(ε) is defined as:

λ(ε)=−2Re{\tilde{y}₀(ε)^{H}[(IN₀+Σ₀(1−α))⁻¹−(IN₀+Σ₀(1−α))⁻¹]\tilde{y}ₜ(ε)},

where α represents the correlation between two OFDM symbols in time and

\tilde{y}ₖ(ε)=QYₖ(ε),

where Q is the IFFT matrix and Yₖ(ε) is the FFT of signal k, compensated for the frequency offset ε.

Thereby an appropriate definition of the log-likelihood function λ(ε) is achieved, leading to an improved estimation of the normalised frequency offset value ε.

In a seventh possible implementation of the method according to the second aspect, or any previous possible implementation thereof, the method further comprises estimating the maximum value of the Karhunen-Loeve approximation of the log-likelihood function λ(ε) by application of an optimisation algorithm comprised in the group, such as the Newton-Raphson method, the Secant method, the Backtracking line search, the Nelder-Mead method and/or golden section search, or other similar methods.

Using a known, reliable optimisation algorithm to estimate the maximum value of the Karhunen-Loeve approximation of the log-likelihood function λ(ε), a simplified implementation is enabled.

In an eighth possible implementation of the method according to the second aspect, or any previous possible implementation thereof, the method may comprise estimating the maximum value of the Karhunen-Loeve approximation of the log-likelihood function λ(ε) by selecting P values ε such that ε∈{ε₁, ε₂, . . . , ε_{P}} within [−0.5, 0.5], computing P values of the Karhunen-Loeve approximation of λ(ε) at ε∈{ε₁, ε₂, . . . , ε_{P}}, determining the biggest value of the Karhunen-Loeve approximation of λ(ε), denoted by λₘₐₓ, as λₘₐₓ=max λ(εₘ), 1≦m≦P, and corresponding value of ε denoted εₘₐₓ, and utilising the determined biggest value λₘₐₓ and corresponding value εₘₐₓ as a starting point in a line search algorithm to find the maximum of the Karhunen-Loeve approximation of λ(ε).

Thereby an improved algorithm for estimating the maximum value of the Karhunen-Loeve approximation of the log-likelihood function λ(ε) is achieved, leading to an improved estimation of the frequency offset value ε.

In a ninth possible implementation of the method according to the second aspect, or any previous possible implementation thereof, the method further comprises, determining, when having determined the biggest value λₘₐₓ and corresponding value εₘₐₓ, that the maximum value of the Karhunen-Loeve approximation of λ(ε) is within an interval:

$$ɛ ∈ \frac{2 {ɛ}_{max} - 2 - P}{2 P} , \frac{2 {ɛ}_{max} - P}{2 P} .$$

Thereby a further improvement is made, leading to an improved estimation of the frequency offset value ε.

In a tenth possible implementation of the method according to the second aspect, or any previous possible implementation thereof, the method further comprises finding the maximum value of the Karhunen-Loeve approximation of λ(ε) within the determined interval with M iterations, using an optimisation algorithm comprised in the group, such as the Newton-Raphson method, the Secant method, the Backtracking line search, the Nelder-Mead method and/or golden section search, or other similar methods.

Using a known, reliable optimisation algorithm to estimate the maximum value of the Karhunen-Loeve approximation of the log-likelihood function λ(ε) within the determined interval with M iterations, a simplified implementation is enabled.

According to a third aspect, a computer program comprising program code for performing a method according to the second aspect, when the computer program is performed on a processor.

Thereby, an ML estimation, or near-ML estimation of the frequency offset is provided, which improves significantly and non-trivially over the currently conventional solutions at an affordable complexity cost. Using the transmitted pilot signals yᵣ₁, yᵣ₂ that anyway are transmitted by the transmitter for other purposes, an estimation of the FFO may be made without addition of any dedicated of signalling, which is an advantage. Therefore, due to the herein disclosed aspect, FFO may be estimated considerably faster and with less computational effort than according to conventional solutions such as the extended baseline algorithm. Thereby, an improved and near optimal algorithm in the sense that it is extremely close to exact ML estimation is achieved. Thus an improved performance within a wireless communication system is provided. Other objects, advantages and novel features of the aspects of the disclosed solutions will become apparent from the following detailed description.

### BRIEF DESCRIPTION OF THE DRAWINGS

Various embodiments will be more readily understood by reference to the following description, taken with the accompanying drawings, in which the drawings include the following.

FIG. 1A is an illustration of system architecture comprising a transmitter and a receiver, according to an embodiment.

FIG. 1B is an illustration of system architecture comprising a transmitter and a receiver, according to an embodiment.

FIG. 2 is a flow chart illustrating a method according to some embodiments.

FIG. 3 is a diagram illustrating a comparison between a method according to some embodiments and other approaches.

FIG. 4 is a flow chart illustrating a method according to some embodiments.

FIG. 5 is a block diagram illustrating a receiver according to an embodiment.

### DETAILED DESCRIPTION

Embodiments described herein are defined as a receiver and a method in a receiver, which may be put into practice in the embodiments described below. These embodiments may, however, be exemplified and realised in many different forms and are not to be limited to the examples set forth herein, rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

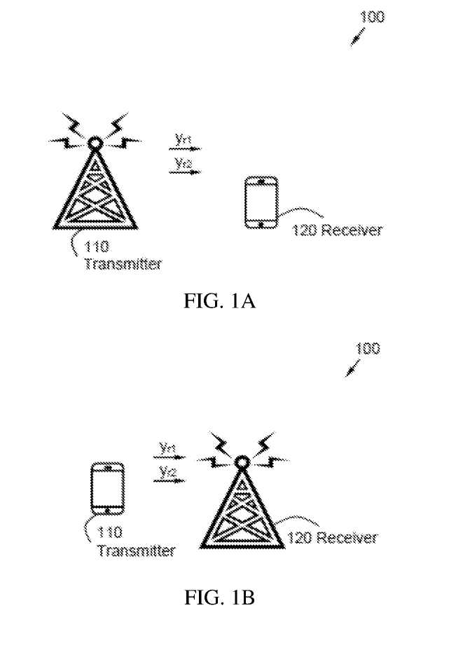

FIG. 1A is a schematic illustration over a wireless communication system 100 comprising a transmitter 110 communicating with a receiver 120. In the illustrated example, a first pilot signal yᵣ₁ and a second pilot signal yᵣ₂ are transmitted by the transmitter 110 to be received by the receiver 120. The first pilot signal yᵣ₁ may be received at the time r1 and the second pilot signal yᵣ₂ may be received at the time r2.

The wireless communication system 100 may at least partly be based on any arbitrary OFDM based access technology such as, e.g. 3GPP LTE, LTE-Advanced, LTE fourth generation mobile broadband standard, Evolved Universal Terrestrial Radio Access Network (E-UTRAN), Worldwide Interoperability for Microwave Access (WIMAX), WI-FI, just to mention some few options.

The wireless communication system 100 may be configured to operate according to the Time-Division Duplex (TDD), or Frequency Division Duplexing (FDD) principles for multiplexing, according to different embodiments.

In the illustrated wireless communication system 100 the transmitter 110 is comprised in a radio network node and the receiver 120 is comprised in a UE, wherein the radio network node may be serving one or more cells.

The purpose of the illustration in FIG. 1A is to provide a simplified, general overview of the methods and nodes, such as the transmitter 110 and receiver 120 herein described, and the functionalities involved. The methods, transmitter 110 and receiver 120 will subsequently, as a non-limiting example, be described in a 3GPP/LTE environment, but the embodiments of the disclosed methods, transmitter 110 and receiver 120 may operate in a wireless communication system 100 based on another access technology such as, e.g. any of the above enumerated. Thus, although the embodiments of the method are described based on, and using the lingo of, 3GPP LTE systems, it is by no means limited to 3GPP LTE.

The transmitter 110 may according to some embodiments be referred to as, e.g. a radio network node, a base station, a NodeB, an evolved Node Bs (eNBs or eNodeBs), a base transceiver station, an Access Point Base Station, a base station router, a Radio Base Stations (RBS), a macro base station, a micro base station, a pico base station, a femto base station, a Home eNodeB, a sensor, a beacon device, a relay node, a repeater or any other network node configured for communication with the receiver 120 over a wireless interface, depending, e.g., of the radio access technology and terminology used.

The receiver 120 may correspondingly, in some embodiments, be represented by, e.g. a UE, a wireless communication terminal, a mobile cellular phone, a Personal Digital Assistant (PDA), a wireless platform, a mobile station, a portable communication device, a laptop, a computer, a wireless terminal acting as a relay, a relay node, a mobile relay, a Customer Premises Equipment (CPE), a Fixed Wireless Access (FWA) nodes or any other kind of device configured to communicate wirelessly with the transmitter 110, according to different embodiments and different vocabulary used.

However, in other alternative embodiments, as illustrated in FIG. 1B, the situation may be reversed. Thus the receiver 120 in some embodiments may be represented by, e.g. a radio network node, a base station, a NodeB, an eNB, or eNodeB, a base transceiver station, an Access Point Base Station, a base station router, an RBS, a macro base station, a micro base station, a pico base station, a femto base station, a Home eNodeB, a sensor, a beacon device, a relay node, a repeater or any other network node configured for communication with the transmitter 110 over a wireless interface, depending, e.g., of the radio access technology and terminology used.

Thereby, also in some such alternative embodiments the transmitter 110 may be represented by, e.g. a UE, a wireless communication terminal, a mobile cellular phone, a PDA, a wireless platform, a mobile station, a portable communication device, a laptop, a computer, a wireless terminal acting as a relay, a relay node, a mobile relay, a CPE, a FWA nodes or any other kind of device configured to communicate wirelessly with the receiver 120, according to different embodiments and different vocabulary used.

The transmitter 110 is configured to transmit radio signals comprising information to be received by the receiver 120. Correspondingly, the receiver 120 is configured to receive radio signals comprising information transmitted by the transmitter 110.

The illustrated network setting of one receiver 120 and one transmitter 110 in FIG. 1A and FIG. 1B respectively, are to be regarded as non-limiting examples of different embodiments only. The wireless communication system 100 may comprise any other number and/or combination of transmitters 110 and/or receiver/s 120, although only one instance of a receiver 120 and a transmitter 110, respectively, are illustrated in FIG. 1A and FIG. 1B, for clarity reasons. A plurality of receivers 120 and transmitters 110 may further be involved in some embodiments.

Thus whenever “one” or “a/an” receiver 120 and/or transmitter 110 is referred to in the present context, a plurality of receivers 120 and/or transmitter 110 may be involved, according to some embodiments.

A system model will subsequently be described. Let sᵣ₁ and sᵣ₂ denote the received OFDM symbols at time r1 and r2, respectively. Further, it may be assumed that time synchronisation and IFO compensation have been carried out such that the CP has been removed from the two symbols and the CFO is at most 0.5 in magnitude (i.e., only the FFO remains). Let \tilde{s}ᵣ₁ and \tilde{s}ᵣ₂ denote the two signals in the case of no FFO at all. Then:

sₖ=Dₖ(ε_{FFO})\tilde{s}ₖ, kε{r1,r2},

where Dₖ (ε_{FFO}) is the diagonal matrix:

$${D}_{k} ( {ɛ}_{FFO} ) = diag {\{ exp ( 2 π i {ɛ}_{FFO} [ \frac{n - 1}{{N}_{FFT}} + k Δ ] ) \}}_{n = 1}^{{N}_{FFT}} ,$$

where N_{FFT} is the FFT-size and Δ is the separation of the two symbols sᵣ₁ and sᵣ₂ measured in units of one OFDM symbol length including the CP.

Example: when the CP is N_{CP} samples long, then:

Δ=(r2−r1)(N_{FFT}+N_{CP})/N_{FFT}.

Due to the CP, we get that Δ>t. The observed signals by the receiver reads y₀, yₜ where yₖ=sₖ+nₖ and nₖ is zero mean proper complex Gaussian noise with covariance matrix N₀I.

Let Q denote the Discrete Fourier Transform (DFT) matrix of size N_{FFT}. Thus QDₖ^{H} (ε_{FFO})sₖ=Hₖxₖ, where Hₖ is a diagonal matrix comprising the frequency response of the channel along its main diagonal and xₖ is a column vector with the transmitted frequency symbols. The vector xₖ comprises both training symbols and payload data. Let [symbol] ₖ denote the set of positions of xₖ that are allocated to training symbols. Also, xₖ=pₖ+dₖ where pₖ is the vector of training symbols satisfying pₖ[l]=0, 1∉ [symbol] k, i.e., there is no training symbols at the data positions, and dₖ are the data symbols satisfying dₖ[l]=0, l∈ [symbol] ₖ, i.e., there is no data at the training positions. It may be assumed that the pilot positions are not dependent on the OFDM symbol index, hence [symbol] ᵣ= [symbol] ₜ= [symbol] .

The problem of FFO estimation is well known and has a long and rich history. There are two main branches for FFO estimation, (1) time-domain approaches and (2) frequency domain approaches.

In the time-domain approach, the redundancy added in the CP, is utilised. Several disadvantages are however associated with this approach such as, e.g., that the estimators suffers from problems with direct current (DC) offsets, spurs and narrow band interferences.

When describing a periodic function in the frequency domain, DC offset, or the DC bias/DC component/DC coefficient as it also may be referred to, is the mean value of the waveform. If the mean amplitude is zero, there is no DC offset.

Within the frequency domain approaches, the baseline method is to make the approximation:

zₖ=Qsₖ≈exp(i2πε_{FFO}Δ)Hₖxₖ,

that is, after the FFT, the FFO shows up multiplicatively at each sub-carrier.

Thermal noise on the observations has here been omitted. At the positions specified in the pilot position set [symbol] , the symbols in xₖ are known. Thereby, the FFO may be estimated as:

$${\hat{ɛ}}_{FFO} = \frac{1}{2 πΔ} arg \{ {\sum }_{l ∈ ϒ} \frac{{z}_{r 1}^{H} [ l ]}{{p}_{r 1}^{H} [ l ]} \frac{{z}_{r 2} [ l ]}{{p}_{r 2} [ l ]} \} .$$

The baseline frequency based estimator however suffers from two main problems:

(i) The first problem is that the approximation zₖ=Qsₖ≈exp(i2πε_{FFO}Δ)Hₖxₖ is only an approximation, and introduces additional noise into the system. It is not optimal in any sense, although complexity wise attractive.

(ii) The second problem is that it is limited to a maximal FFO of ½_{Δ}. In LTE, a typical value for Δ may be approximately, e.g. 3.21, which results from using OFDM symbol 4 and 7 within each sub-frame and using the normal CP. This means that the maximal FFO possible to detect is only |ε_{FFO}<εₘₐₓ. ½_{Δ}=0.1667≈2.33 kHz. This is far less than half the sub-carrier spacing of 7.5 kHz. As a remedy to the second problem, an extension of the base-line in order to extend the maximal FFO to 0.5—corresponding to 7.5 kHz in LTE may be made according to some conventional solutions. However, such solution comprises the use of more than two OFDM symbols in the FFO estimation. Further, the problem (i) is not dealt with and will ultimately limit the performance.

Yet another method to deal with the second (ii) problem is to use three identical copies of the baseline method in order to cover three times as large FFO interval. The first copy is shifted in frequency into 4.66 kHz, and the third copy is shifted to 4.66 kHz. The second copy is not shifted and is the normal baseline method. After the frequency shifts, an evaluation may be made:

$${\hat{ɛ}}_{FFO} = \frac{1}{2 πΔ} arg \{ {\sum }_{l ∈ ϒ} \frac{{z}_{r 1}^{H} [ l ]}{{p}_{r 1}^{H} [ l ]} \frac{{z}_{r 2} [ l ]}{{p}_{r 2} [ l ]} \} ,$$

three times, once for each frequency shift. Then the final output is the estimate with maximal value of:

$${\sum }_{l ∈ ϒ} \frac{{z}_{r 1}^{H} [ l ]}{{p}_{r 1}^{H} [ l ]} \frac{{z}_{r 2} [ l ]}{{p}_{r 2} [ l ]} .$$

This algorithm may be referred to as “extended baseline”. However, this algorithm performs poorly, as it does not adequately address the problem (i).

According to some embodiments, the objective of the method is to perform a ML estimation of the FFO, that is:

\hat{ε}_{FFO}=arg max_{φ}Pr(yᵣ₁,yᵣ₂;φ),

where Pr(yᵣ₁,yᵣ₂; φ) is the likelihood function for the FFO given the two observed signals yᵣ₁,yᵣ₂ where yₖ=sₖ+nₖ and nₖ is zero mean proper complex Gaussian noise with covariance matrix N₀I. Further, a target may be to deal with an FFO that is uniformly distributed in the interval [−0.5, 0.5]. Note that as ML estimation is targeted, it is not possible to improve over the herein disclosed method.

The ML estimator may in some embodiments be conceptually uncomplicated to implement. The bottleneck is that the complexity of a straightforward implementation is prohibitive. As quasi-ML algorithm may be utilised as a remedy, wherein the result is virtually indistinguishable from full ML while at the same time having low computational cost.

The complexity of the proposed method may in some embodiments be essentially three times the baseline method plus a small overhead.

The key observation behind the provided method is that a Karhunen-Loeve approximation, up to any finite order of a log-likelihood function λ(φ)=log Pr(yᵣ₁,yᵣ₂; φ), wherein, from now and onwards, it is omitted to explicitly denote the dependency of yᵣ₁,yᵣ₂ on λ(φ), is for all practical purposes three dimensional. This means that when the log-likelihood function λ(φ) is evaluated at three positions, complete information may be obtained about the entire function λ(φ). To compute those three values, may involve approximately three times the complexity of the baseline method. Then a search over λ(φ) may follow, and this search is of less complexity than the baseline method itself.

With the notation introduced earlier, the log-likelihood of the frequency offset hypothesis ε_{FFO}=φ given the received signals yᵣ₁,yᵣ₂ is:

$$λ ( φ ) ∝ - {[ \begin{matrix}{P}_{r 1}^{- 1} {QD}_{r 1}^{H} ( φ ) {y}_{r 1} \\ {P}_{r 2}^{- 1} {QD}_{r 2}^{H} ( φ ) {y}_{r 2}\end{matrix} ]}^{H} {( Λ + {N}_{0} {I}_{2 {N}_{FFT}} )}^{- 1} [ \begin{matrix}{P}_{r 1}^{- 1} {QD}_{r 1}^{H} ( φ ) {y}_{r 1} \\ {P}_{r 2}^{- 1} {QD}_{r 2}^{H} ( φ ) {y}_{r 2}\end{matrix} ] ,$$

where Pₖ is a diagonal matrix with pₖ along its diagonal, and the matrix Λ is the covariance matrix of the channel in the frequency domain, i.e.:

$$Λ = E [ {[ \begin{matrix}diag ( {H}_{r 1} ) \\ diag ( {H}_{r 2} )\end{matrix} ] [ \begin{matrix}diag ( {H}_{r 1} ) \\ diag ( {H}_{r 2} )\end{matrix} ]}^{H} ] ,$$

where diag(X) is a column vector with elements taken from the main diagonal of X. Thus the correlation model can be written as:

$$Λ = E \{ [ \begin{matrix}{H}_{0}^{H} \\ {H}_{t}^{H}\end{matrix} ] [ {H}_{0} {H}_{t} ] \} = [ \begin{matrix}{Λ}_{00} & {Λ}_{0 t} \\ {Λ}_{t 0} & {Λ}_{tt}\end{matrix} ]$$

In LTE test cases, the correlation model is separable, which means that Λ may be written in the form:

In this correlation model, Λ₀ represents the covariance among the sub-carriers at any given OFDM symbol, while α represents the correlation between two OFDM symbols in time. Due to the Doppler effect, α<1 in general, as α is reversely proportional to the Doppler effect. During channel estimation stages, the matrix Λ₀ may be classified as one out of the EPA, EVA, and ETU correlation models, and an estimate of α may also be at hand. With that, it remains to compute the values:

μ₋₁=λ_{c}(−1/tΔ)

μ₀=λ(0)

μ₁=λ_{c}(1/tΔ),

where λ(ε)=Re(λ_{c}(ε)). Further, the likelihood λ_{c}(ε) may be computed at any given value of ε. Define:

$$F = \frac{1}{\sqrt{2}} [ \begin{matrix}Q & - Q \\ - Q & - Q\end{matrix} ] .$$

The covariance matrix Λ+N₀I_{2N}_{_{FFT}} may then be factorised as:

Λ+N₀I_{2N}_{_{FFT}}=F^{H}ΣF,

where

$$Σ = [ \begin{matrix}{IN}_{0} + {Σ}_{0} ( 1 + α ) & 0 \\ 0 & {IN}_{0} + {Σ}_{0} ( 1 - α )\end{matrix} ] .$$

Σ₀ being a diagonal matrix containing the eigenvalues of Λ₀ along its diagonal. Further, define Yₖ(ε)=Pₖ⁻¹Q^{H}Dₖyₖ. The likelihood function may then be written:

$$λ ( ɛ ) = - {[ \begin{matrix}{Y}_{0} ( ɛ ) \\ {Y}_{t} ( ɛ )\end{matrix} ]}^{H} {F}^{H} {Σ}^{- 1} F [ \begin{matrix}{Y}_{0} ( ɛ ) \\ {Y}_{t} ( ɛ )\end{matrix} ] ,$$

where λ(ε)=Re(λ_{c}(ε)). Now define \tilde{y}ₖ(ε)=QYₖ(ε). The final expression for a simplified likelihood function may then be written as:

λ_{c}(ε)=−2Re₀{\tilde{y}₀(ε)^{H}[(IN₀+Σ₀(1−α))⁻¹−(IN₀+Σ₀(1−α))⁻¹]\tilde{y}ₜ(ε)} (1)

It may be noted that the full matrix Λ₀ may not be needed, since equation (1) only utilises its eigenvalues Σ₀.

A comparison may be made with the corresponding simplified correlation model formula utilised in the legacy method

$$Λ = [ \begin{matrix}I & I \\ I & I\end{matrix} ] .$$

In that case, one reaches the formula for the likelihood function becomes:

λ(ε)=−2Re{Y₀(ε)^{H}Yₜ(ε)} (2)

From a complexity point of view there are three times as many terms in Equation (1) compared with Equation (2). Therefore complexity becomes three times as high. Further, one additional FFT operation must be carried out for every received symbol. The reason is that in Equation (1), the signal \tilde{y}ₖ (ε)=QYₖ(ε) is used, while in Equation (2) the signal Yₖ(ε) may be used directly. This adds to the computational load.

In cases where the correlation Λ₀ is not known, one can resort to a worst case assumption given the length of the CP. In LTE, the CP length may always be known. The worst correlation type for a given length of the CP corresponds to:

$${Σ}_{0} = [ \begin{matrix}\frac{{N}_{FFT}}{{N}_{CP}} & & & & & \\ & ⋱ & & & & \\ & & \frac{{N}_{FFT}}{{N}_{CP}} & & & \\ & & & 0 & & \\ & & & & ⋱ & \\ & & & & & 0\end{matrix} ] \qquad ( 3 )$$

The number of non-zero diagonal elements equals the CP-length N_{CP}. This choice corresponds to the assumption that the power-delay-profile of the channel is uniform over its delay spread which is less than, or equal to, the CP-length. Since it reflects the delay spread of the channel, it is superior to the choice made in legacy methods.

A full ML estimator may then compute the value λ(ε) for all possible ε, quantised to the desired accuracy, and then select as output the c that maximises λ(ε). This is, however, of impractical complexity, why a more economical method may be pursued.

The function λ(ε) is a random function, and it therefore possesses a Karhunen-Loeve basis expansion as:

λ_{c}(ε)=Σₖαₖθₖ(ε),

where θₖ(ε) are eigenfunctions of the kernel:

K(ε₁,ε₂)=E[λ_{c}(ε₁)λ_{c}(ε₂)]

The key observation is now that most eigenvalues of K(ε₁, ε₂) are very small. In fact, only three of the eigenvalues comprises around 99.9% of the total mass of the kernel. More precisely, let βₖ denote the eigenvalues of K(ε₁, ε₂) corresponding to the eigenfunctions θₖ(ε), and sort the eigenvalues in descending order. Then, for all LTE settings, it is observed that:

$${β}_{1} + {β}_{2} + {β}_{3} > 0.999 {\sum }_{k} {β}_{k} .$$

The implication of this observation is that the log-likelihood function λ(ε) is, for all practical purposes, three dimensional, i.e.:

λ(ε)=Σₖαₖθₖ(ε)≅λ₃(ε)Σₖ₌₁³αₖθₖ(ε).

Finding a closed form for the eigenfunctions θₖ(ε) may be difficult as they change for the different LTE settings. For that reason, another set of functions has to be found that covers as much mass as possible of the kernel. Such set of three basis functions has not been found. However, by ignoring to take the real-value of the likelihood function, the calculations may be reduced to:

λ_{c}(ε)≈α₋₁exp(−i2πε(Δt−0.5)+α₀exp(−i2πε(Δt)+α₁exp(−i2πε(Δt+0.5),

where the three coefficients are chosen so that:

μ₋₁=λ_{c}(−1/tΔ)

μ₀=λ_{c}(0)

μ₁=λ_{c}(1/tΔ)

is satisfied, and where the Karhunen-Loeve representation of the likelihood function is then taken as:

λ(ε)≈Re(λ_{c}(ε))=Re(α₋₁exp(−i2πε(Δt−0.5)+α₀exp(−i2πε(Δt)+α₁exp(−i2πε(Δt+0.5)).

Further, the log-likelihood function λ(ε) is defined as:

λ(ε)=−2Re{\tilde{y}₀(ε)^{H}└(IN₀+Σ₀(1−α))⁻¹−(IN₀+Σ₀(1−α))⁻¹┘\tilde{y}ₜ(ε)},

where α represents the correlation between two OFDM symbols in time and \tilde{y}ₖ(ε)=QYₖ(ε), where Q is the IFFT, matrix and Yₖ(ε) is the FFT, of signal k, compensated for the frequency offset ε.

At this point, an approximation λ₃(ε) to the log-likelihood λ(ε) has been established, namely:

$$λ ( ɛ ) ≅ {λ}_{3} ( ɛ ) = Re \{ {λ}_{3}^{c} ( ɛ ) \} = Re \{ {\sum }_{k = 1}^{3} {α}_{k} {ϕ}_{k} ( ɛ ) \} .$$

This is a remarkable result, as the complexity of computing one value of the log-likelihood thereby becomes very low as only three multiplications may be required, which saves computing resources and time.

Next step is to estimate the FFO. On the most fundamental level, any optimisation algorithm that can find the maximum of an arbitrary function f(x) may be applied. However, in some embodiments, the following algorithm may be used.

1. Select P values ε such that ε∈{ε₁, ε₂, . . . , ε_{P}} within [−0.5, 0.5].

2. Compute P values of the Karhunen-Loeve approximation of λ(ε) at ε∈{ε₁, ε₂, . . . , ε_{P}}.

3. Determine the biggest value of the Karhunen-Loeve approximation of λ(ε), denoted by λₘₐₓ, λₘₐₓ=max λ(εₘ), 1≦m≦P, and corresponding value of ε denoted εₘₐₓ.

The maximum value of the Karhunen-Loeve approximation of λ(ε) may be found within the determined interval with M iterations, using an optimisation algorithm comprised in the group, the Newton-Raphson method, the Secant method, the Backtracking line search, the Nelder-Mead method and/or golden section search, or other similar methods.

4. Utilise the determined biggest value λₘₐₓ and corresponding value εₘₐₓ as a starting point in a line search algorithm to find the maximum of the Karhunen-Loeve approximation of λ(ε).

When having determined the biggest value λₘₐₓ and corresponding value εₘₐₓ, it may be determined that the maximum value of the Karhunen-Loeve approximation of λ(ε) is within an interval:

$$ɛ ∈ \frac{2 {ɛ}_{max} - 2 - P}{2 P} , \frac{2 {ɛ}_{max} - P}{2 P} .$$

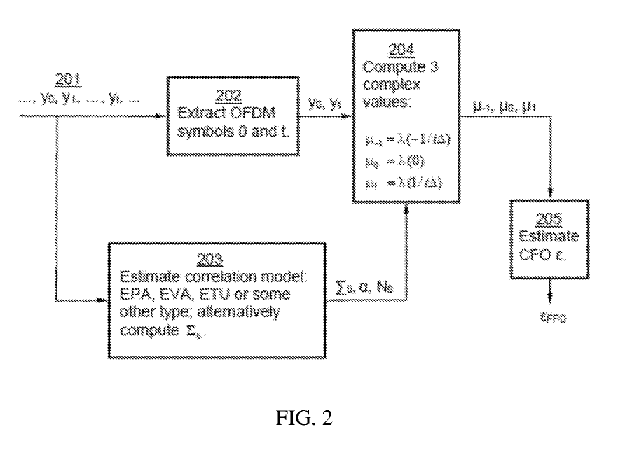

FIG. 2 illustrates an example of the discussed method, divided into a number of steps 201-205.

Step 201 comprises receiving a first pilot signal yᵣ₁ and a second pilot signal yᵣ₂, from the transmitter 110. In step 202, OFDM symbols are extracted. Step 203 comprises estimating correlation model: EPA, EVA, ETU or some other type. Alternatively Σ₀ may be computed. Step 204 comprises computing 3 complex values μ₋₁, μ₀, and μ₁, as previously specified by a complex extension of a log-likelihood function λ(ε), based on the estimated correlation model. Having computed μ₋₁, μ₀, and μ₁, the CFO ε may be estimated at step 205.

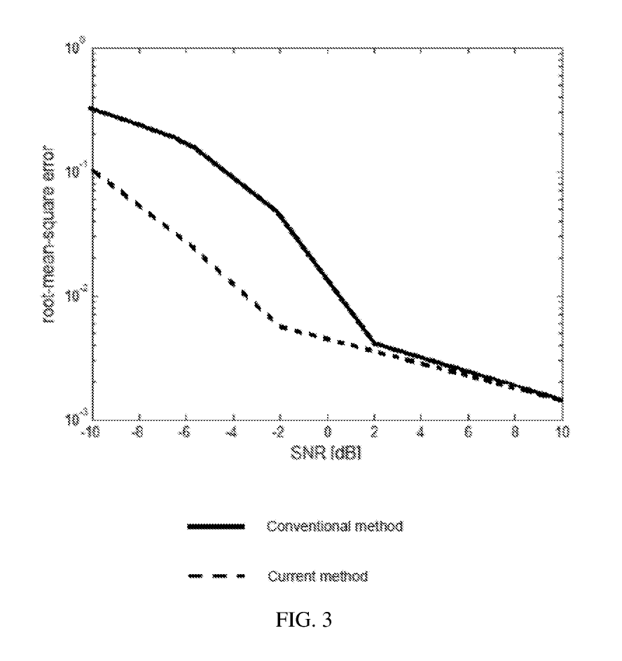

FIG. 3 illustrates performance of the current method in comparison to the conventional solution.

A case may be considered with 256 sub-carriers, i.e., N_{FFT}=256. The channels may be generated according to an EVA correlation model, and the Doppler level may be set such that α=0.9. For simplicity, it may be assumed an all-pilot case, meaning that there is no payload date in the OFDM symbols 0 and t. Moreover, t=3 may be chosen, which follows the LTE standard as the spacing between two pilot-carrying OFDM symbols is 3. The CP-length is set to 15, i.e., N_{CP}=15. The estimator is using the robust correlation model in equation (3). The performance results are shown in FIG. 3. The solid line curve is the root-mean-square error of the method according to conventional solutions, that is, by computing the three likelihoods μ₋₁, μ₀, μ₁, using equation (2). The dashed line curve is the performance of an embodiment which computes the three values according to equation (1), with Σ₀ according to equation (3). As can be seen, there is about 5 decibel (dB) gain at low Signal to Noise Ratio (SNR).

Instead of the herein used measurement SNR, any other similar appropriate measurement may be utilised in other embodiments, such as, e.g. Signal-to-Interference-plus-Noise Ratio (SINR), Signal-to-Interference Ratio (SIR), Signal-to-Noise-plus-Interference Ratio (SNIR), Signal-to-Quantization-Noise Ratio (SQNR), Signal, noise and distortion (SINAD), or any inverted ratio such as Noise to Signal ratio, which compare the level of a desired signal to the level of background noise in a ratio.

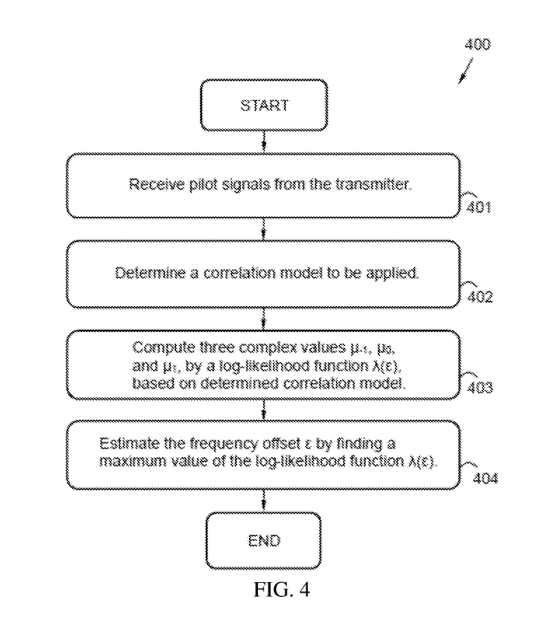

FIG. 4 illustrates an example of a method 400 in a receiver 120 according to some embodiments, for estimating a normalised frequency offset between a transmitter 110 and the receiver 120 in a wireless communication system 100, based on OFDM.

The normalised frequency offset may be a FFO, which also may be expressed: ε_{FFO}, where ε_{FFO}∈[−½,½].

The wireless communication system 100 may be, e.g. a 3GPP LTE system in some embodiments.

The receiver 120 may be represented by a mobile terminal or UE, and the transmitter 110 may be represented by a radio network node or eNodeB, or vice versa, in different embodiments.

However, in some embodiments, both the transmitter 110 and the receiver 120 may be represented by radio network nodes forming a backhaul link. Thanks to embodiments herein, tuning and adjustment of the respective radio network nodes may be simplified, and the communication link may be upheld, also when, e.g. transmitter warmth creates or renders additional frequency offset.

Also, one or both of the transmitter 110 and/or the receiver 120 may be mobile, e.g. a mobile relay node or micro node on the roof of a bus, forming a backhaul link with a macro node.

Further, both the transmitter 110 and the receiver 120 may be represented by mobile terminals in an ad-hoc network communication solution.

To appropriately estimate the normalised frequency offset between transmitter 110 and receiver 120, the method 400 may comprise a number of steps 401-404.

It is however to be noted that any, some or all of the described steps 401-404, may be performed in a somewhat different chronological order than the enumeration indicates, be performed simultaneously or even be performed in a completely reversed order according to different embodiments. Further, it is to be noted that some steps 401-404 may be performed in a plurality of alternative manners according to different embodiments, and that some such alternative manners may be performed only within some, but not necessarily all embodiments. The method 400 may comprise the following steps.

Step 401: Receive pilot signals from the transmitter.

A first pilot signal yᵣ₁ and a second pilot signal yᵣ₂ are received from the transmitter 110.

The first pilot signal yᵣ₁ is received at time r1 and the second pilot signal yᵣ₂ is received at time r2, where r1≠r2.

The pilot signals yᵣ₁, yᵣ₂ are wireless radio signals, transmitted, e.g. in a single frequency, transmitted over the wireless communication system 100 for supervisory, control, equalization, continuity, synchronisation, and/or reference purposes.

Using the transmitted pilot signals yᵣ₁, yᵣ₂ that anyway are transmitted by the transmitter 110 for other purposes, an estimation of the FFO may be made without addition of any dedicated signalling, which is an advantage.

Step 402: Determine a correlation model to be applied.

A correlation model to be applied is determined based on correlation among involved sub-carrier channels at the first pilot signal yᵣ₁ and the second pilot signal yᵣ₂.

Such correlation model may comprise, e.g. any of EPA, EVA, ETU correlation models when the correlation among involved sub-carrier channels at the first pilot signal yᵣ₁ and the second pilot signal yᵣ₂ is known. In some embodiments, the correlation model may comprise:

$${Σ}_{0} = [ \begin{matrix}\frac{{N}_{FFT}}{{N}_{CP}} & & & & & \\ & ⋱ & & & & \\ & & \frac{{N}_{FFT}}{{N}_{CP}} & & & \\ & & & 0 & & \\ & & & & ⋱ & \\ & & & & & 0\end{matrix} ] ,$$

wherein Σ₀ a diagonal matrix comprising the eigenvalues of the covariance among the sub-carriers at any given OFDM symbol, N_{cp} is length of a CP, and N_{FFT} is number of sub-carriers of the received pilot signals yᵣ₁, yᵣ₂.

Step 403: Compute three complex values μ₋₁, μ₀, and μ₁, by a log-likelihood function λ(ε), based on the determined correlation model.

Three complex values μ₋₁, μ₀, and μ₁, are computed by a complex extension of a log-likelihood function λ(ε), based on the determined correlation model.

Step 404: Estimate the frequency offset value ε by finding a maximum value of the log-likelihood function λ(ε).

The frequency offset value ε is estimated by finding a maximum value of a Karhunen-Loeve approximation of the log-likelihood function λ(ε), based on the computed three complex values μ₋₁, μ₀, and μ₁.

The maximum value of the log-likelihood function λ(ε) may be approximated by a Karhunen-Loeve approximation of λ(ε), based on the computed three complex values μ₋₁, μ₀, and

μ₋₁=λ_{c}(−1/tΔ)

μ₀=λ_{c}(0)

μ₁=λ_{c}(1/tΔ),

where t is the distance between the received pilot signals yᵣ₁, yᵣ₂, Δ=(N_{FFT}+N_{CP})/N_{FFT}, and the likelihood function satisfies λ(ε)=Re(λ_{c}(ε)).

The Karhunen-Loeve approximation of λ_{c}(ε) may be given by:

λ_{c}(ε)≈α₋₁exp(−i2πε(Δt−0.5)+α₀exp(−i2πε(Δt)+α₁exp(−i2πε(Δt+0.5),

where the three coefficients are chosen so that:

μ₋₁=λ_{c}(−1/tΔ)

μ₀=λ_{c}(0)

μ₁=λ_{c}(1/tΔ)

is satisfied, and wherein the Karhunen-Loeve representation of the likelihood function may then be taken as:

Δ(ε)≈Re(λ_{c}(ε))=Re(α₋₁exp(−i2πε(Δt−0.5)+α₀exp(−i2πε(Δt)+α₁exp(−i2πε(Δt+0.5)).

The log-likelihood function λ(ε) may be defined as:

λ(ε)=−2Re{\tilde{y}₀(ε)^{H}└(IN₀+Σ₀(1−α))⁻¹−(IN₀+Σ₀(1−α))⁻¹┘\tilde{y}ₜ(ε)},

wherein α represents the correlation between two OFDM symbols in time and \tilde{y}ₖ(ε)=QYₖ(ε), where Q is the IFFT matrix and Yₖ(ε) is the FFT of signal k, compensated for the frequency offset ε.

The maximum value of the Karhunen-Loeve approximation of the log-likelihood function λ(ε) may be made by application of an optimisation algorithm comprised in the group the Newton-Raphson method, the Secant method, the Backtracking line search, the Nelder-Mead method and/or golden section search, or other similar methods.

The maximum value of the Karhunen-Loeve approximation of the log-likelihood function λ(ε) by selecting P values ε such that ε∈{ε₁, ε₂, . . . , ε_{P}} within [−0.5, 0.5], computing P values of the Karhunen-Loeve approximation of λ(ε) at ε∈{ε₁, ε₂, . . . , ε_{P}}, determining the biggest value of the Karhunen-Loeve approximation of λ(ε), denoted by λₘₐₓ, as λₘₐₓ=max λ(εₘ), 1≦m≦P, and corresponding value of ε denoted εₘₐₓ, and utilising the determined biggest value λₘₐₓ and corresponding value εₘₐₓ as a starting point in a line search algorithm to find the maximum of the Karhunen-Loeve approximation of λ(ε).

Having determined the biggest value λₘₐₓ and corresponding value εₘₐₓ, it may be determined that the maximum value of the Karhunen-Loeve approximation of λ(ε) is within an interval:

$$ɛ ∈ \frac{2 {ɛ}_{max} - 2 - P}{2 P} , \frac{2 {ɛ}_{max} - P}{2 P} .$$

The maximum value of the Karhunen-Loeve approximation of λ(ε) within the determined interval with M iterations may be made using an optimisation algorithm comprised in the group the Newton-Raphson method, the Secant method, the Backtracking line search, the Nelder-Mead method and/or golden section search, or other similar methods.

By performing the disclosed estimation by the quasi ML method 400, but not a full ML algorithm, accurate frequency offset estimation is achieved, without introducing the complex, time consuming and resource demanding efforts that a full ML algorithm would require. Thereby, time and computational power are saved.

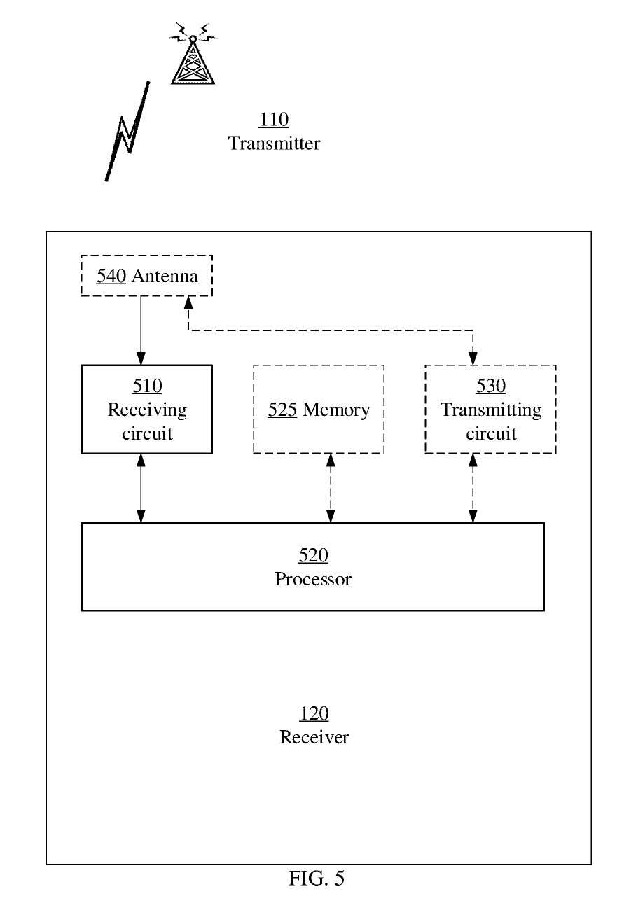

FIG. 5 illustrates an embodiment of a receiver 120 comprised in a wireless communication system 100. The receiver 120 is configured for performing at least some of the previously described method steps 401-404, for estimating a normalised frequency offset between a transmitter 110 and the receiver 120 in a wireless communication system 100, based on OFDM. The wireless communication network 100 may be based on 3GPP LTE.

Thus the receiver 120 is configured for performing the method 400 according to at least some of the steps 401-404. For enhanced clarity, any internal electronics or other components of the receiver 120, not completely indispensable for understanding the herein described embodiments has been omitted from FIG. 5.

The receiver 120 comprises a receiving circuit 510 configured to receive a first pilot signal yᵣ₁ and a second pilot signal yᵣ₂ from the transmitter 110. The receiver 120 may also be configured for receiving wireless signals from the transmitter 110 or from any other entity configured for wireless communication over a wireless interface according to some embodiments.

Furthermore, the receiver 120 comprises a processor 520 configured to determine a correlation model based on correlation among involved sub-carrier channels at the first pilot signal yᵣ₁ and the second pilot signal yᵣ₂. The processor 520 is also configured to compute three complex values μ₋₁, μ₀, and μ₁, by a complex extension of a log-likelihood function λ(ε), based on the determined correlation model. Further, the processor 520 is also configured to estimate the normalised frequency offset value ε by finding a maximum value of the log-likelihood function λ(ε), based on the computed three complex values μ₋₁, μ₀, and μ₁.

The determined correlation model comprises any of EPA, EVA, ETU, correlation models when the correlation among involved sub-carrier channels at the first pilot signal yᵣ₁ and the second pilot signal yᵣ₂ is known.

The processor 520 may also be configured to compute:

$${Σ}_{0} = [ \begin{matrix}\frac{{N}_{FFT}}{{N}_{CP}} & & & & & \\ & ⋱ & & & & \\ & & \frac{{N}_{FFT}}{{N}_{CP}} & & & \\ & & & 0 & & \\ & & & & ⋱ & \\ & & & & & 0\end{matrix} ] ,$$

where Σ₀ a diagonal matrix comprising the eigenvalues of the covariance among the sub-carriers at any given OFDM symbol, N_{cp} is length of a CP, and N_{FFT} is number of sub-carriers of the received pilot signals yᵣ₁, yᵣ₂.

The processor 520 may in addition be configured to compute the maximum value of the log-likelihood function λ(ε) is approximated by a Karhunen-Loeve approximation of λ(ε), based on the computed three complex values μ₋₁, μ₀, and μ₁, where:

μ₋₁=λ_{c}(−1/tΔ)

μ₀=λ_{c}(0)

μ₁=λ_{c}(1/tΔ),

where t is the distance between the received pilot signals yᵣ₁, yᵣ₂, Δ=(N_{FFT}+N_{CP})/N_{FFT}, and the likelihood function satisfies λ(ε)=Re(λ_{c}(ε)).

The processor 520 may in addition be configured to compute the Karhunen-Loeve approximation of λ_{c}(ε), given by:

λ_{c}(ε)≈α₋₁exp(−i2πε(Δt−0.5)+α₀exp(−i2πε(Δt)+α₁exp(−i2πε(Δt+0.5),

where the three coefficients are chosen so that:

μ₋₁=λ_{c}(−1/tΔ)

μ₀=λ_{c}(0)

μ₁=λ_{c}(1/tΔ)

is satisfied, and wherein the Karhunen-Loeve representation of the likelihood function is then taken as:

λ(ε)≈Re(λ_{c}(ε))=Re(α₋exp(−i2πε(Δt−0.5)+α₀exp(−i2πε(Δt)+α₁exp(−i2πε(Δt+0.5)).

The log-likelihood function λ(ε) may be defined as:

λ(ε)=−2Re{\tilde{y}₀(ε)^{H}[(IN₀+Σ₀(1−α))⁻¹−(IN₀+Σ₀(1−α))⁻¹]\tilde{y}ₜ(ε)},

wherein α represents the correlation between two OFDM symbols in time and \tilde{y}ₖ (ε)=QYₖ(ε), where Q is the IFFT matrix and Yₖ(ε) is the FFT of signal k, compensated for the frequency offset ε.

The processor 520 may in addition be configured to estimate the maximum value of the Karhunen-Loeve approximation of the log-likelihood function λ(ε) by application of an optimisation algorithm comprised in the group the Newton-Raphson method, the Secant method, the Backtracking line search, the Nelder-Mead method and/or golden section search, or other similar methods.

The processor 520 may also be configured to estimate the maximum value of the Karhunen-Loeve approximation of the log-likelihood function λ(ε) by selecting P values ε such that ε∈{ε₁, ε₂, . . . , ε_{P}} within [−0.5, 0.5], computing P values of the Karhunen-Loeve approximation of λ(ε) at ε∈{ε₁, ε₂, . . . , ε_{P}}, determining the biggest value of the Karhunen-Loeve approximation of λ(ε), denoted by λₘₐₓ, as λₘₐₓ=max λ(εₘ), 1≦m≦P, and corresponding value of ε denoted εₘₐₓ, and utilising the determined biggest value λₘₐₓ and corresponding value εₘₐₓ as a starting point in a line search algorithm to find the maximum of the Karhunen-Loeve approximation of λ(ε).

The processor 520 may further be configured to determine when having determined the biggest value λₘₐₓ and corresponding value εₘₐₓ, that the maximum value of the Karhunen-Loeve approximation of λ(ε) is within an interval:

$$ɛ ∈ \frac{2 {ɛ}_{max} - 2 - P}{2 P} , \frac{2 {ɛ}_{max} - P}{2 P} .$$

The processor 520 may be further configured to find the maximum value of the Karhunen-Loeve approximation of λ(ε) within the determined interval with M iterations, using an optimisation algorithm comprised in the group the Newton-Raphson method, the Secant method, the Backtracking line search, the Nelder-Mead method and/or golden section search, or other similar methods.

Such processor 520 may comprise one or more instances of a processing circuit, i.e. a CPU, a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

In addition according to some embodiments, the receiver 120, in some embodiments, may also comprise at least one memory 525 in the receiver 120. The optional memory 525 may comprise a physical device utilised to store data or programs, i.e., sequences of instructions, on a temporary or permanent basis in a non-transitory manner. According to some embodiments, the memory 525 may comprise integrated circuits comprising silicon-based transistors. Further, the memory 525 may be volatile or non-volatile.

In addition, the receiver 120 may comprise a transmitting circuit 530 configured for transmitting wireless signals within the wireless communication system 100.

Furthermore, the receiver 120 may also comprise an antenna 540. The antenna 540 may optionally comprise an array of antenna elements in an antenna array in some embodiments.

The steps 401-404 to be performed in the receiver 120 may be implemented through the one or more processors 520 in the receiver 120 together with computer program product for performing the functions of the steps 401-404.

Thus a non-transitory computer program comprising program code for performing the method 400 according to any of steps 401-404, for estimating frequency offset between a transmitter 110 and the receiver 120 in a wireless communication system 100, based on OFDM, when the computer program is loaded into a processor 520 of the receiver 120.

The non-transitory computer program product mentioned above may be provided for instance in the form of a non-transitory data carrier carrying computer program code for performing at least some of the steps 401-404 according to some embodiments when being loaded into the processor 520. The data carrier may be, e.g. a hard disk, a compact-disc read-only memory (CD ROM) disc, a memory stick, an optical storage device, a magnetic storage device or any other appropriate medium such as a disk or tape that may hold machine readable data in a non-transitory manner. The non-transitory computer program product may furthermore be provided as computer program code on a server and downloaded to the receiver 120, e.g., over an Internet or an intranet connection.

The terminology used in the description of the embodiments as illustrated in the accompanying drawings is not intended to be limiting of the described method 400 and/or receiver 120. Various changes, substitutions and/or alterations may be made, without departing from the solution embodiments as defined by the appended claims.

As used herein, the term “and/or” comprises any and all combinations of one or more of the associated listed items. The term “or” as used herein, is to be interpreted as a mathematical OR, i.e., as an inclusive disjunction, not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as, e.g. a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

What is claimed is:

1. A receiver, for estimating a normalised frequency offset value (ε) between a transmitter and the receiver in a wireless communication system, based on Orthogonal Frequency Division Multiplexing (OFDM), the receiver comprising:
a receiving circuit configured to receive a first pilot signal (yᵣ₁) and a second pilot signal (yᵣ₂) from the transmitter; and
a processor coupled to the receiver circuit and configured to:
determine a correlation model based on correlation among involved sub-carrier channels at the yᵣ₁ and the yᵣ₂;
compute three complex values (μ₋₁, μ₀, and μ₁), by a complex extension of a log-likelihood function (λ(ε)), based on the determined correlation model; and
estimate the ε by finding a maximum value of the λ(ε), based on the computed μ₋₁, μ₀, and μ₁.

2. The receiver according to claim 1, wherein the processor is further configured to determine the correlation model based on any of Extended Pedestrian A (EPA), Extended Vehicular A (EVA), Extended Typical Urban (ETU), correlation models when the correlation among involved sub-carrier channels at the yᵣ₁ and the yᵣ₂ is known.

3. The receiver according to claim 1, wherein the processor is further configured to determine the correlation model by computing QΣ₀Q^{H}, wherein Q is the Inverse Fast Fourier Transform (IFFT) matrix, wherein Σ₀ is
$${Σ}_{0} = [ \begin{matrix}\frac{{N}_{FFT}}{{N}_{CP}} & & & & & \\ & ⋱ & & & & \\ & & \frac{{N}_{FFT}}{{N}_{CP}} & & & \\ & & & 0 & & \\ & & & & ⋱ & \\ & & & & & 0\end{matrix} ] ,$$
wherein Σ₀ a diagonal matrix comprising eigenvalues of a covariance among the sub-carriers at any given OFDM symbol, wherein N_{cp} is length of a Cyclic Prefix (CP), and wherein N_{FFT} is number of sub-carriers of the yᵣ₁, yᵣ₂ when the correlation among involved sub-carrier channels at the yᵣ₁ and the yᵣ₂ is unknown.

4. The receiver according to claim 1, wherein the processor is further configured to approximate the maximum value of the λ(ε) by a Karhunen-Loeve approximation of λ(ε), based on the computed μ₋₁, μ₀, and μ₁, wherein μ₋₁=λ_{c}(−1/tΔ), wherein μ₀=λ_{c}(0), wherein μ₁=λ_{c}(1/tΔ), wherein t is a distance between the yᵣ₁ and yᵣ₂, and wherein Δ=(N_{FFT}+N_{cp})/N_{FFT}.

5. The receiver according to claim 4, wherein the processor is further configured to perform the Karhunen-Loeve approximation of λ(ε), and wherein the λ(ε) satisfies the condition λ(ε)=Re(λ_{c}(ε)).

6. The receiver according to claim 4, wherein the processor is further configured to perform the Karhunen-Loeve approximation of λ_{c}(ε) given by the equation λ_{c}(ε)≈α₋₁exp(−i2πε(Δt−0.5)+α₀exp(−i2πε(Δt)+α₁exp(−i2πε(Δt+0.5), wherein the three coefficients are chosen such that μ₋₁=λ_{c}(−1/tΔ), μ₀=λ_{c}(0), and μ₁=λ_{c}(1/tΔ) is satisfied, and wherein the Karhunen-Loeve representation of the likelihood function is then taken as λ(ε)≈Re(λ_{c}(ε))=Re(α₋₁exp(−i2πε(Δt−0.5)+α₀exp(−i2πε(Δt)+α₁exp(−i2πε(Δt+0.5)).

7. The receiver according to claim 1, wherein the processor is further configured to perform a Karhunen-Loeve approximation of λ_{c}(ε), wherein the λ(ε) is defined as λ(ε)=−2Re{\tilde{y}₀(ε)^{H}└(IN₀+Σ₀(1−α))⁻¹−(IN₀+Σ₀(1−α))⁻¹┘\tilde{y}ₜ(ε)}, wherein at represents a correlation between two OFDM symbols in time, wherein \tilde{y}ₖ(ε)=QYₖ(ε), wherein Q is the Inverse Fast Fourier Transform (IFFT) matrix, and wherein Yₖ(ε) is the Fast Fourier Transform (FFT) of signal k compensated for the ε.

8. The receiver according to claim 1, wherein the processor is further configured to estimate a maximum value of a Karhunen-Loeve approximation of the λ(ε) by application of an optimisation algorithm such as the Newton-Raphson method.

9. The receiver according to claim 1, wherein the processor is further configured to estimate a maximum value of a Karhunen-Loeve approximation of the λ(ε) by application of an optimisation algorithm such as the Secant method.

10. The receiver according to claim 1, wherein the processor is further configured to estimate a maximum value of a Karhunen-Loeve approximation of the λ(ε) by application of an optimisation algorithm such as the Backtracking line search.

11. The receiver according to claim 1, wherein the processor is further configured to estimate a maximum value of a Karhunen-Loeve approximation of the λ(ε) by application of an optimisation algorithm such as the Nelder-Mead method.

12. The receiver according to claim 1, wherein the processor is further configured to estimate a maximum value of a Karhunen-Loeve approximation of the λ(ε) by application of an optimisation algorithm such as golden section search.

13. The receiver according to claim 1, wherein when estimating a maximum value of a Karhunen-Loeve approximation of the λ(ε), the processor is further configured to:
select P values of ε such that ε∈{ε₁, ε₂, . . . , ε_{P}} within [−0.5, 0.5];
compute P values of the Karhunen-Loeve approximation of the λ(ε) at ε∈{ε₁, ε₂, . . . , ε_{P}};
determine the biggest value of the Karhunen-Loeve approximation of the λ(ε) (λₘₐₓ), as λₘₐₓ=max λ(εₘ), wherein 1≦m≦P, and wherein corresponding value of ε denoted εₘₐₓ; and
utilise the determined λₘₐₓ and εₘₐₓ as a starting point in a line search algorithm to find the maximum of the Karhunen-Loeve approximation of the λ(ε).

14. The receiver according to claim 13, wherein, the processor is further configured to determine that the maximum value of the Karhunen-Loeve approximation of the λ(ε) is within an interval ε
$$ɛ ∈ \frac{2 {ɛ}_{max} - 2 - P}{2 P} , \frac{2 {ɛ}_{max} - P}{2 P}$$
when the λₘₐₓ and εₘₐₓ are determined.

15. The receiver according to claim 14, wherein the processor is further configured to find the maximum value of the Karhunen-Loeve approximation of λ(ε) within the determined interval with M iterations, using an optimisation algorithm such as the Newton-Raphson method.

16. The receiver according to claim 14, wherein the processor is further configured to find the maximum value of the Karhunen-Loeve approximation of λ(ε) within the determined interval with M iterations, using an optimisation algorithm such as the Secant method.

17. The receiver according to claim 14, wherein the processor is further configured to find the maximum value of the Karhunen-Loeve approximation of λ(ε) within the determined interval with M iterations, using an optimisation algorithm comprised in a group such as the Backtracking line search, the Nelder-Mead method or golden section search.

18. The receiver according to claim 1, wherein the receiver is represented by a User Equipment (UE), and wherein the transmitter is represented by a radio network node.

19. The receiver according to claim 1, wherein the receiver is represented by a radio network node, and wherein the transmitter is represented by a User Equipment (UE).

20. A method applied to a receiver, for estimating a normalised frequency offset value (ε) between a transmitter and the receiver in a wireless communication system, based on Orthogonal Frequency Division Multiplexing (OFDM), the method comprising:
receiving a first pilot signal (yᵣ₁) and a second pilot signal (yᵣ₂), from the transmitter;
determining a correlation model to be applied based on correlation among involved sub-carrier channels at the yᵣ₁ and the yᵣ₂;
computing three complex values (μ₋₁, μ₀, and μ₁), by a complex extension of a log-likelihood function (λ(ε)), based on the determined correlation model; and
estimating the ε by finding a maximum value of a Karhunen-Loeve approximation of the λ(ε), based on the computed μ₋₁, μ₀, and μ₁.
